(19) United States
(12) Patent Application Publication
(10) Pub. No.: US 2007/0230774 A1
(43) Pub. Date: Oct. 4, 2007

(54) Identifying optimal colors for calibration and color filter array design

(75) Inventor: Farhan A. Baqai, Fremont, CA (US)

Correspondence Address: Jonathan O. Owens;HAVERSTOCK & OWENS LLP, 162 North Wolfe Road, Sunnyvale, CA, 94086, US

(73) Assignees: Sony Corporation; Sony Electronics Inc.

(21) Appl. No.: 11/395,120

(22) Filed: Mar. 31, 2006

(51) Int. Cl. G06K 9/00

(52) U.S. Cl. 382/162

(57) ABSTRACT

A color determination method utilizes color matching functions to approximate the imaging system's sensitivity characteristics. The illuminant conditions are modeled according to known illuminant intensity versus wavelength functions. Non-negative Matrix Factorization (NMF) is applied to a set of known reflectance data to decompose the known reflectance data set into a defined number of NMF basis vectors. In general, for an N-color based imaging system, N NMF basis functions are determined. Since basis functions provided by NMF are non-negative, the determined N NMF basis functions are related to actual physical colors. The NMF basis vectors are integrated with the illuminate conditions and color matching function(s) that approximate the imaging system's sensitivity to generate XYZ color values. These are converted to RGB values which are used to determine the optimal N colors for the N-color based imaging system.

### FIELD OF THE INVENTION

The present invention relates to the field of color image processing and calibration. More particularly, the present invention relates to the field of identifying optimal colors for calibration and color filter array design.

### BACKGROUND OF THE INVENTION

The ability of a color imaging system to produce color images is greatly dependent on the corresponding illuminant, reflectance, and imaging system sensitivity. An illuminant serves as a source of light. Illuminants are well known and consist of a relatively few different types, for example, daylight, flourescent light, and incandescent light. As such, illuminants are easily modeled.

Imaging system sensitivity is a function of the system components. For example, an imaging system's sensitivity to red, green, and blue light is dependent on the ability of a red filter, a green filter, and a red filter to detect the corresponding light. As the particular components of any given imaging system are known, the imaging system sensitivity is readily obtainable.

Reflectance represents the reflected light from an object, and as such, reflectance represents a physical characteristic of the object. Every object reflects light to one degree or another. With so many different possible reflectances, a general reflectance function is difficult to model. As such, data reduction models are necessary to represent reflectance data.

Data reduction methods are used which attempt to estimate certain characteristics of the image data, for example reflectance data, thereby reducing the image data to a smaller, more manageable data set. Data reduction methods attempt to achieve a basis function, which is a characteristic function of the data.

Finding appropriate basis functions to represent color spectra is an ongoing effort. Conventional techniques for generating basis functions include Principal Component Analysis (PCA) and Independent Component Analysis (ICA). The basis vectors provided by PCA correspond to the directions of maximum variance in the space they represent. PCA forces a Gaussian form on the distribution of the data, which may not always be true. PCA provides insight into the dimensionality of color spectra and is useful for efficient coding of the spectra. PCA reduces second order statistical dependencies providing statistically uncorrelated coefficients, and data can be re-entered prior to processing to remove the mean. Use of PCA generates basis functions that are global and span the entire domain, and the first N basis vectors are the same regardless of how many are computed. Implementation of PCA is done with linear algebra methods. A mathematical property of PCA is that basis functions are strictly orthogonal, and have both negative and positive values making them ineligible as physical color spectra. Since PCA determines orthogonal vectors to match the image data, PCA is impractical for data that is not orthogonal.

ICA is another technique for determining basis functions. It produces basis vectors that give rise to maximum statistical independence of the data and reduces the higher order statistical dependencies. ICA attempts to maximize the non-Gaussian nature of the projected data so the basis functions need not be orthogonal to each other. Use of ICA generates basis functions that are global and span the entire domain, and the first N basis vectors are the same regardless of how many are computed, although the order may be different. Implementation requires iterative optimization. Data can be re-entered prior to processing to remove the mean, and different objective functions can be used.

Similar to basis vectors given by PCA, ICA basis vectors have both negative and positive values. Both of these methods are holistic in nature and are therefore ill-suited for learning parts-based representation. PCA and ICA essentially generate basis vectors that lack intuitive meaning. Furthermore, the basis vectors have both positive and negative components, and the data is represented as linear combinations of these vectors with positive and negative coefficients. Optimality is achieved through cancellation effects. In many applications, the negative components contradict physical realities. For instance, the pixels in a grayscale image have non-negative intensities, so an image with negative intensities cannot be reasonably interpreted, and color filters in applications such as digital cameras, copiers, and scanners should have non-negative components. Further, negative color reflectance does not have any physical meaning.

### SUMMARY OF THE INVENTION

Embodiments of a color determination method apply non-negative matrix factorization (NMF) to image processing applications, and the optimal N-colors used by an N-color based imaging system are determined. In this manner, a mathematical rigorous method is used to determine the optimal colors to be used in the imaging system.

In one aspect, a method of determining an optimal N colors for an N color-based imaging system is described. The method includes selecting one or more illuminant conditions, providing a set of measured reflectances, applying a non-negative matrix factorization to the set of measured reflectances to generate a set of non-negative matrix factorization basis vectors, and determining the optimal N colors according to the one or more illuminant conditions, the non-negative matrix factorization basis vectors, and predefined color matching functions. The method can also include calibrating the N color-based imaging system according to the determined N colors. The method can also include configuring the N color-based imaging system with a color filter array comprising N colors. The reflectance conditions can comprise a compilation of measured reflectance characteristics associated with a corresponding set of objects. Determining the N colors can comprise integrating the one or more illuminant conditions, the non-negative matrix factorization basis vectors, and the color matching functions to form an integrated result, and performing a color transformation on the integrated result. Integrating the color matching functions, the reflectance function, and the one or more illuminant conditions can be performed across a determined frequency domain. The frequency domain can comprise the visible light domain. The color matching functions can comprise three color matching functions.

In another aspect, a method of calibrating an N color-based imaging system is described. The method selecting one or more illuminant conditions, providing a set of measured reflectances, applying a non-negative matrix factorization to the set of measured reflectances to generate a set of non-negative matrix factorization basis vectors, determining the optimal N colors according to the one or more illuminant conditions, the non-negative matrix factorization basis vectors, and predefined color matching functions, and calibrating the N color-based imaging system according to the determined N colors. The reflectance conditions can comprise a compilation of measured reflectance characteristics associated with a corresponding set of objects. Determining the N colors can comprise integrating the one or more illuminant conditions, the non-negative matrix factorization basis vectors, and the color matching functions to form an integrated result, and performing a color transformation on the integrated result. Integrating the color matching functions, the reflectance function, and the one or more illuminant conditions can be performed across a determined frequency domain. The frequency domain can comprises the visible light domain. The color matching functions can comprise three color matching functions.

In yet another aspect, a method of configuring an N color-based imaging system is described. The includes selecting one or more illuminant conditions, providing a set of measured reflectances, applying a non-negative matrix factorization to the set of measured reflectances to generate a set of non-negative matrix factorization basis vectors, determining the optimal N colors according to the one or more illuminant conditions, the non-negative matrix factorization basis vectors, and predefined color matching functions, and configuring the N color-based imaging system with a color filter array comprising N colors. The reflectance conditions can comprise a compilation of measured reflectance characteristics associated with a corresponding set of objects. Determining the N colors can comprise integrating the one or more illuminant conditions, the color matching functions, and the non-negative matrix factorization basis vectors to form an integrated result, and performing a color transformation on the integrated result. Integrating the color matching functions, the reflectance function, and the one or more illuminant conditions is performed across a determined frequency domain. The frequency domain can comprise the visible light domain. The color matching functions can comprise three color matching functions.

In still yet another aspect, a computer readable medium includes program instructions for execution on a controller coupled to an N color-based image capturing system. When executed by the controller, the computer readable medium causes the image capturing system to perform selecting one or more illuminant conditions, providing a set of measured reflectances, applying a non-negative matrix factorization to the set of measured reflectances to generate a set of non-negative matrix factorization basis vectors, and determining an optimal N colors for the N color-based image capturing system according to the one or more illuminant conditions, the non-negative matrix factorization basis vectors, and predefined color matching functions. The computer readable medium can further cause calibrating the N color-based imaging system according to the determined N colors. The computer readable medium can further cause configuring the N color-based imaging system with a color filter array comprising N colors. Reflectance conditions can comprise a compilation of measured reflectance characteristics associated with a corresponding set of objects. Determining the optimal N colors can comprises integrating the one or more illuminant conditions, the non-negative matrix factorization basis vectors, and the color matching functions to form an integrated result, and performing a color transformation on the integrated result. Integrating the color matching functions, the reflectance function, and the one or more illuminant conditions can be performed across a determined frequency domain. The frequency domain can comprise the visible light domain. The color matching functions can comprise three color matching functions.

In another aspect, an N color-based image capturing system comprises a processing module configured to select one or more illuminant conditions, to provide a set of measured reflectances, to apply a non-negative matrix factorization to the set of measured reflectances to generate a set of non-negative matrix factorization basis vectors, and to determine the optimal N colors according to the one or more illuminant conditions, the non-negative matrix factorization basis vectors, and predefined color matching functions. The processing module can be further configured to calibrate the image capturing system according to the determined optimal N colors. The image capturing system can also include an image sensing module including a color filter array configured to detect the optimal N colors. The image sensing module can comprise a single-chip image sensor. The image sensing module can comprise a multiple-chip image sensor. The reflectance conditions can comprise a compilation of measured reflectance characteristics associated with a corresponding set of objects. The processing module can be configured to determine the N colors by integrating the one or more illuminant conditions, the color matching functions, and the non-negative matrix factorization basis vectors to form an integrated result, and performing a color transformation on the integrated result. The processing module can be configured to integrate the color matching functions, the reflectance function, and the one or more illuminant conditions across a determined frequency domain. The frequency domain can comprise the visible light domain. The color matching functions can comprise three color matching functions.

### BRIEF DESCRIPTION OF THE DRAWINGS

FIG. 1 illustrates a first method of determining the optimal N colors for an N-color based imaging system.

FIG. 2 illustrates a NMF basis vector corresponding to a 1-color requirement.

FIG. 3 illustrates NMF basis vectors corresponding to a 2-color requirement.

FIG. 4 illustrates NMF basis vectors corresponding to a 3-color requirement.

FIG. 5 illustrates NMF basis vectors corresponding to a 4-color requirement.

FIG. 6 illustrates NMF basis vectors corresponding to a 5-color requirement.

FIG. 7 illustrates a block diagram of an exemplary image capturing system configured to operate according to the color determination method.

Embodiments of the color determination method are described relative to the several views of the drawings. Where appropriate and only where identical elements are disclosed and shown in more than one drawing, the same reference numeral will be used to represent such identical elements.

### DETAILED DESCRIPTION OF THE EMBODIMENTS

Non-negative matrix factorization (NMF) is a method that provides basis functions and coefficients that are always non-negative. NMF can be applied to the computation of reflectance basis vectors in the following manner. The m, n-dimensional reflectance measurements, for example from a Macbeth color chart, are combined into a n×m matrix V. This matrix is approximately factored into a n×r matrix W and an r×m matrix H, where r<m, n. In this manner, a non-negative matrix V is approximated by the expression V≈WH. The approximation for matrix V can be rewritten column by column as v≈Wh, where v and h are the corresponding columns of V and H. In other words, each data vector v is approximated by a linear combination of columns of W, weighted by the components of h. Therefore, the matrix W can be regarded as containing a basis that is optimized for the linear approximation for the data in the matrix V. Since relatively few basis vectors are used to represent many data vectors, good approximation can only be achieved if the basis vectors discover structure that is latent in the data. The cost functions and the update rules for two NMF algorithms are provided by Lee and Seung. NMF has been used to obtain parts-based representations of human faces. The W matrix includes positive values which are representative of the “face parts” such as eyes, noses, mouths, etc. The H matrix includes positive values which are used as weighting values. These weighting values represent how the face-parts are added to generate a completed human face.

In general, NMF provides basis functions and coefficients that are always non-negative, where only additive combinations are allowed, implementation requires iterative optimization, different objective functions can be used, and data cannot be re-centered and must remain non-negative. The basis functions generated by NMF can be local, have no zero crossings, can correspond to physical or conceptual features in a non-negative space, vary according to the number computed, and are non-orthogonal unless non-overlapping.

As discussed above, image output quality of an imaging system is a function of the reflectance function, the illuminant conditions, and the imaging system sensitivity. Embodiments of the color determination method utilize known color matching functions (CMFs) to approximate the imaging system's sensitivity characteristics. The CMFs are defined by the Commission Internationale de l'Eclairage (CIE), which is also referred to as the International Commission on Illumination. The illuminant conditions are modeled according to known illuminant intensity versus wavelength functions. NMF is applied to a set of known reflectance colors to decompose the known reflectance data set into a defined number of NMF basis vectors. In general, for an N-color based imaging system, N NMF basis functions are determined. Since basis functions provided by NMF are non-negative, the determined N NMF basis functions are related to actual physical colors. In this manner, the reflectance data set is simplified into “dominant” colors through application of NMF.

The N NMF basis vectors are integrated with the illuminate conditions and color matching function(s) to generate N XYZ color values. The XYZ color values are converted to RGB values which are used to determine the optimal N colors for the N-color based imaging system.

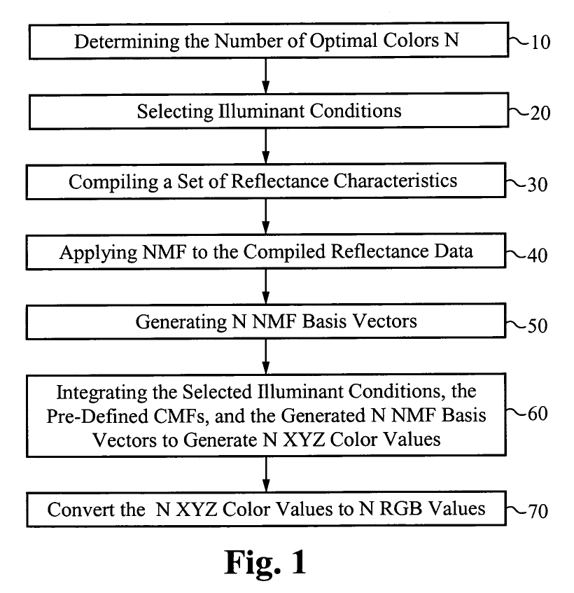

FIG. 1 illustrates a first method of determining the optimal N colors for an N-color based imaging system. At the step 10, the optimal number of colors N is determined. This determination is based on the imaging system used. Typically, higher end imaging system utilize more colors than lower end imaging systems. A 3-color based imaging system, for example, utilizes a 3-color CFA. At the step 20, the illuminant conditions are selected. An illuminant condition specifies the illuminant intensity versus wavelength at specific environmental conditions. For example, a D65 illuminant function specifies the illuminant intensity versus wavelength at 6500 degrees Kelvin. In one embodiment, a single illuminant function is selected as the illuminant condition. In other embodiments, more than one illuminant function is selected.

At the step 30, a set of reflectance characteristics is compiled. Reflectance characteristics are obtained from a variety of sources, including but not limited to, a Macbeth chart, Munsell colors, skin, gravures, photo-paper, transparency film, inkjet printers, flowers, leaves, Krinov database, paints, natural objects, and man-made objects. At the step 40, a non-negative matrix factorization (NMF) is applied to the set of reflectance characteristics compiled in the step 30. As a result of applying NMF to the set of reflectance characteristics at the step 40, N NMF basis vectors are generated at the step 50. The N NMF basis vectors represent the color spectra of the set of reflectance characteristics. Each NMF basis vector is re-scaled such that the maximum value of any of the basis vectors becomes one. Alternatively, each NMF basis vector is re-scaled in any other appropriate manner.

At the step 60, the selected illuminant condition(s) from the step 20, the generated N NMF basis functions from the step 50, and pre-defined CIE CMFs are integrated to generate N XYZ color values, also referred to as tristimulus primaries. In some embodiments, three CIE CMFs are used, one for each X, Y, and Z color value in the tristimulus domain. At the step 70, the N XYZ color values are converted to N RGB values. Where appropriate, any negative RGB values are clipped. Each RGB color value corresponds to one optimal color within the N-color based imaging system.

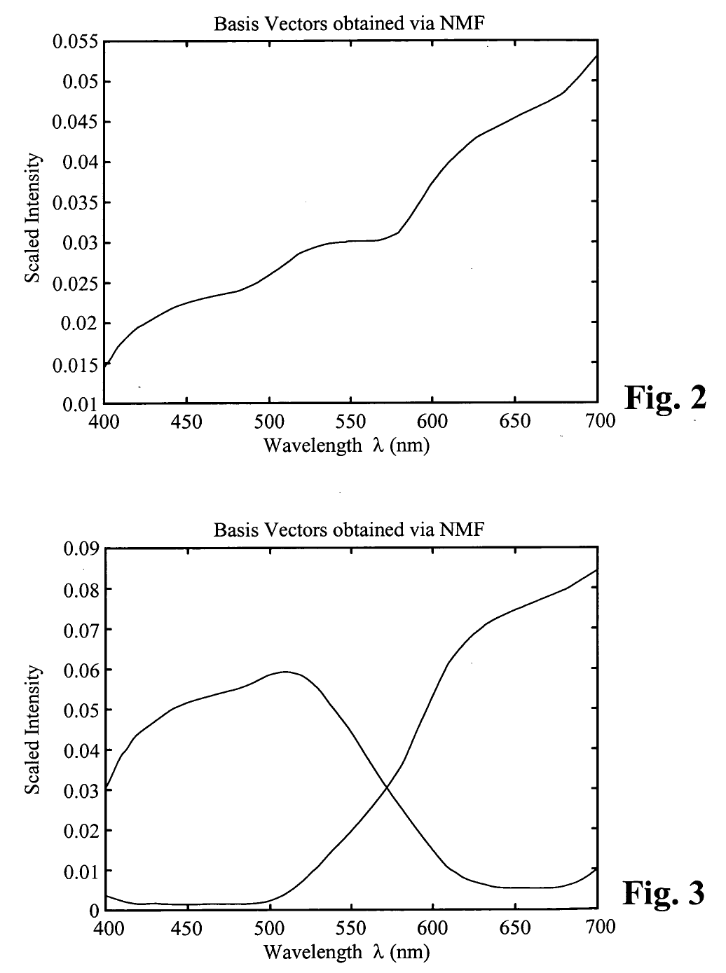

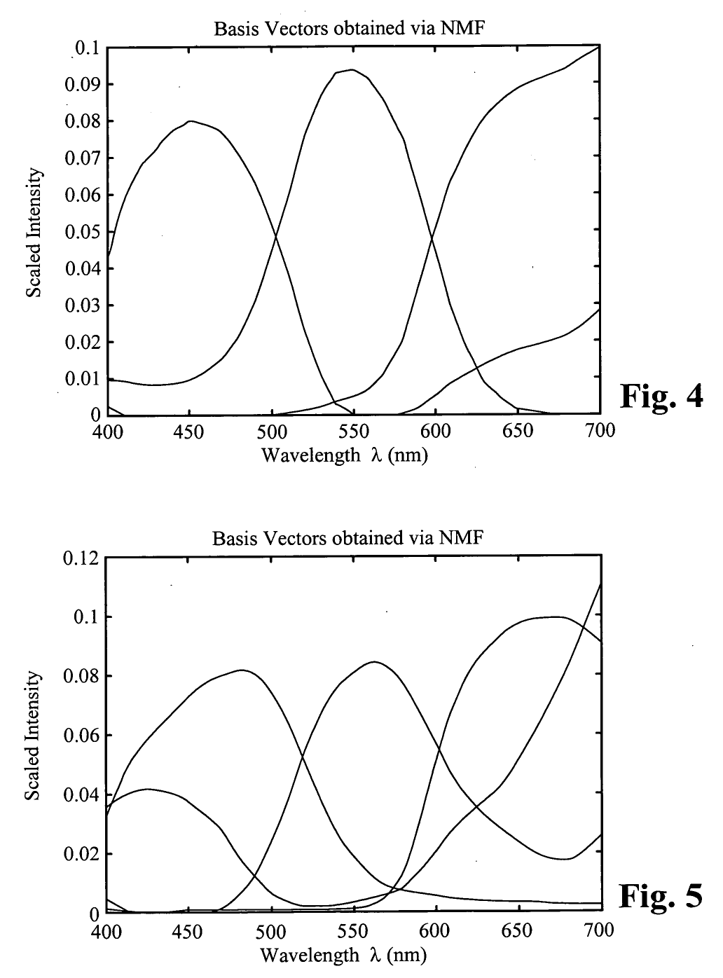

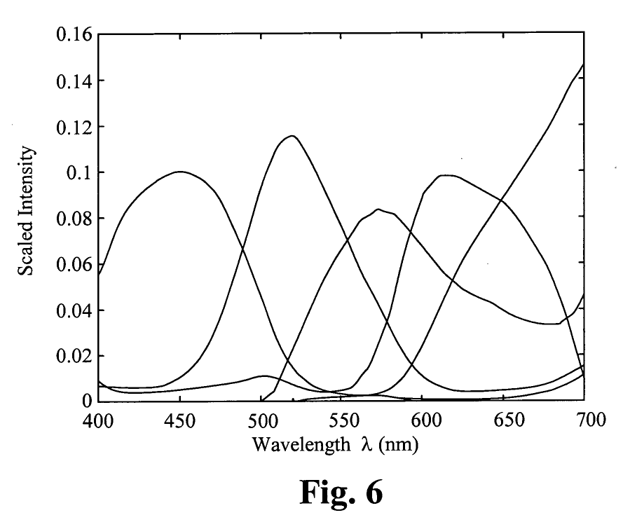

FIGS. 2-6 illustrate graphs of the NMF basis vectors for various color optimizations. Each graph measures scaled intensity versus wavelength λ. FIG. 2 illustrates a NMF basis vector corresponding to a 1-color requirement. FIG. 3 illustrates NMF basis vectors corresponding to a 2-color requirement. FIG. 4 illustrates NMF basis vectors corresponding to a 3-color requirement. FIG. 5 illustrates NMF basis vectors corresponding to a 4-color requirement. FIG. 6 illustrates NMF basis vectors corresponding to a 5-color requirement. It is understood that the NMF basis vectors can be generated for any N-color requirement.

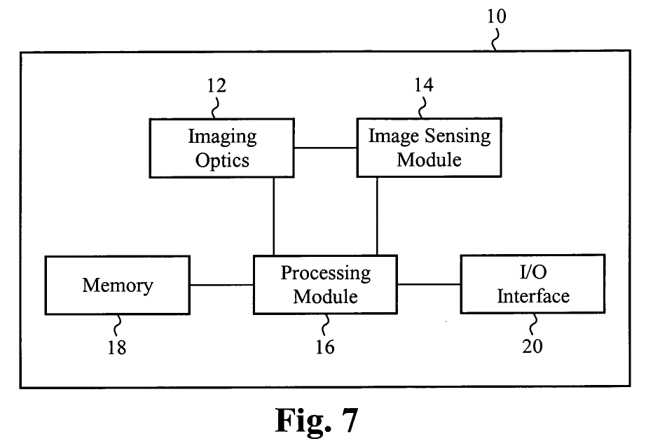

In one embodiment, the color determination method is implemented as a computer program utilized in an image capturing system, such as a camera or a camcorder. Use of the color determination method enables optimal color selection for the image capturing system. FIG. 7 illustrates a block diagram of an exemplary image capturing system 10 configured to operate according to the color determination method. The image capturing system 10 is any device capable of capturing an image or video sequence. The image capturing system 10 includes imaging optics 12, an image sensing module 14, a processing module 16, a memory 18, and an input/output (I/O) interface 20. The imaging optics 12 include any conventional optics to receive an input light representative of an image to be captured, to filter the input light, and to direct the filtered light to the image sensing module 14. Alternatively, the imaging optics 12 do not filter the input light. The image sensing module 14 includes one or more sensing elements to detect the filtered light. Alternatively, the image sensing module 14 includes a color filter array to filter the input light and one or more sensing elements to detect the light filtered by the color filter array. In one embodiment, the image sensing module 14 consists of a single-chip image sensor. In an alternative embodiment, the image sensing module 14 consists of a multiple-chip image sensor.

The memory 18 can include both fixed and removable media using any one or more of magnetic, optical or magneto-optical storage technology or any other available mass storage technology. The processing module 16 is configured to control the operation of the image capturing system 10. In some embodiments, the processing module 16 is also configured to utilize the color determination method described above. The I/O interface 20 includes a user interface and a network interface. In some embodiments, the user interface includes a display to show user instructions, feedback related to input user commands, and/or the images captured and processed by the imaging optics 12, the image sensing module 14, and the processing module 16. The network interface 20 includes a physical interface circuit for sending and receiving imaging data and control communications over a conventional network.

Two exemplary applications for the color determination method includes image system calibration and optimal color selection in color filter array (CFA) design for image systems containing a single-chip image sensor.

For image system calibration, it is of interest to determine the optimal number of colors required for calibration. Conventionally, this was not possible since the data reduction methods ICA and PCA generated basis vectors that have negative components. Such basis vectors are classified as statistical basis vectors and have no physical significance. By using NMF, it is possible to determine the minimum set of optimal colors required for image system calibration. Since NMF generates basis functions that are positive definite, these basis vectors are directly related to physical colors.

In CFA design, to reduce cost and size, most digital still cameras and camcorders use a single-chip image sensor. These imaging systems use CFAs to obtain different color information. Traditionally, red, green, and blue colors in the form of a Bayer pattern are used. For three colors, red, green, and blue color are optimal. However, optimal colors for a CFA that has more than 3 colors are not conventionally known. Recently, to improve color accuracy, there has been considerable interest in using more than three colors in the CFA. The color determination method is used to determine optimal colors for a CFA of any size.

Furthermore, as image sensors become cheaper, manufacturers are designing products that have multiple image sensors. Given the high spatial resolution that has already been achieved, the next step to improve quality is to add more colors and have multiple image sensors so that demosaicing operation may be avoided. In such situations, it may be possible to use 5 or even 6 colors. The color determination method determines the best colors to achieve very high color accuracy.

The present invention has been described in terms of specific embodiments incorporating details to facilitate the understanding of the principles of construction and operation of the invention. Such references, herein, to specific embodiments and details thereof are not intended to limit the scope of the claims appended hereto. It will be apparent to those skilled in the art that modifications can be made in the embodiments chosen for illustration without departing from the spirit and scope of the invention.

What is claimed is:

1. A method of determining an optimal N colors for an N color-based imaging system, the method comprising:
a. selecting one or more illuminant conditions;
b. providing a set of measured reflectances;
c. applying a non-negative matrix factorization to the set of measured reflectances to generate a set of non-negative matrix factorization basis vectors; and
d. determining the optimal N colors according to the one or more illuminant conditions, the non-negative matrix factorization basis vectors, and predefined color matching functions.

2. The method of claim 1 further comprising calibrating the N color-based imaging system according to the determined N colors.

3. The method of claim 1 further comprising configuring the N color-based imaging system with a color filter array comprising N colors.

4. The method of claim 1 wherein the reflectance conditions comprise a compilation of measured reflectance characteristics associated with a corresponding set of objects.

5. The method of claim 1 wherein determining the N colors comprises:
a. integrating the one or more illuminant conditions, the non-negative matrix factorization basis vectors, and the color matching functions to form an integrated result; and
b. performing a color transformation on the integrated result.

6. The method of claim 5 wherein integrating the color matching functions, the reflectance function, and the one or more illuminant conditions is performed across a determined frequency domain.

7. The method of claim 6 wherein the frequency domain comprises the visible light domain.

8. The method of claim 1 wherein the color matching functions comprise three color matching functions.

9. A method of calibrating an N color-based imaging system, the method comprising:
a. selecting one or more illuminant conditions;
b. providing a set of measured reflectances;
c. applying a non-negative matrix factorization to the set of measured reflectances to generate a set of non-negative matrix factorization basis vectors;
d. determining the optimal N colors according to the one or more illuminant conditions, the non-negative matrix factorization basis vectors, and predefined color matching functions; and
e. calibrating the N color-based imaging system according to the determined N colors.

10. The method of claim 9 wherein the reflectance conditions comprise a compilation of measured reflectance characteristics associated with a corresponding set of objects.

11. The method of claim 9 wherein determining the N colors comprises:
a. integrating the one or more illuminant conditions, the non-negative matrix factorization basis vectors, and the color matching functions to form an integrated result; and
b. performing a color transformation on the integrated result.

12. The method of claim 11 wherein integrating the color matching functions, the reflectance function, and the one or more illuminant conditions is performed across a determined frequency domain.

13. The method of claim 12 wherein the frequency domain comprises the visible light domain.

14. The method of claim 9 wherein the color matching functions comprise three color matching functions.

15. A method of configuring an N color-based imaging system, the method comprising:
a. selecting one or more illuminant conditions;
b. providing a set of measured reflectances;
c. applying a non-negative matrix factorization to the set of measured reflectances to generate a set of non-negative matrix factorization basis vectors;
d. determining the optimal N colors according to the one or more illuminant conditions, the non-negative matrix factorization basis vectors, and predefined color matching functions; and
e. configuring the N color-based imaging system with a color filter array comprising N colors.

16. The method of claim 15 wherein the reflectance conditions comprise a compilation of measured reflectance characteristics associated with a corresponding set of objects.

17. The method of claim 15 wherein determining the N colors comprises:
a. integrating the one or more illuminant conditions, the color matching functions, and the non-negative matrix factorization basis vectors to form an integrated result; and
b. performing a color transformation on the integrated result.

18. The method of claim 17 wherein integrating the color matching functions, the reflectance function, and the one or more illuminant conditions is performed across a determined frequency domain.

19. The method of claim 18 wherein the frequency domain comprises the visible light domain.

20. The method of claim 15 wherein the color matching functions comprise three color matching functions.

21. A computer readable medium including program instructions for execution on a controller coupled to an N color-based image capturing system, which when executed by the controller, causes the image capturing system to perform:
a. selecting one or more illuminant conditions;
b. providing a set of measured reflectances;
c. applying a non-negative matrix factorization to the set of measured reflectances to generate a set of non-negative matrix factorization basis vectors; and
d. determining an optimal N colors for the N color-based image capturing system according to the one or more illuminant conditions, the non-negative matrix factorization basis vectors, and predefined color matching functions.

22. The computer readable medium of claim 21 further comprising calibrating the N color-based imaging system according to the determined N colors.

23. The computer readable medium of claim 21 further comprising configuring the N color-based imaging system with a color filter array comprising N colors.

24. The computer readable medium of claim 21 wherein the reflectance conditions comprise a compilation of measured reflectance characteristics associated with a corresponding set of objects.

25. The computer readable medium of claim 21 wherein determining the optimal N colors comprises:
a. integrating the one or more illuminant conditions, the non-negative matrix factorization basis vectors, and the color matching functions to form an integrated result; and
b. performing a color transformation on the integrated result.

26. The computer readable medium of claim 25 wherein integrating the color matching functions, the reflectance function, and the one or more illuminant conditions is performed across a determined frequency domain.

27. The computer readable medium of claim 26 wherein the frequency domain comprises the visible light domain.

28. The computer readable medium of claim 21 wherein the color matching functions comprise three color matching functions.

29. An N color-based image capturing system comprising a processing module configured to select one or more illuminant conditions, to provide a set of measured reflectances, to apply a non-negative matrix factorization to the set of measured reflectances to generate a set of non-negative matrix factorization basis vectors, and to determine the optimal N colors according to the one or more illuminant conditions, the non-negative matrix factorization basis vectors, and predefined color matching functions.

30. The image capturing system of claim 29 wherein the processing module is further configured to calibrate the image capturing system according to the determined optimal N colors.

31. The image capturing system of claim 29 further comprising an image sensing module including a color filter array configured to detect the optimal N colors.

32. The image capturing system of claim 29 wherein the image sensing module comprises a single-chip image sensor.

33. The image capturing system of claim 29 wherein the image sensing module comprises a multiple-chip image sensor.

34. The image capturing system of claim 29 wherein the reflectance conditions comprise a compilation of measured reflectance characteristics associated with a corresponding set of objects.

35. The image capturing system of claim 29 wherein the processing module is configured to determine the N colors by:
a. integrating the one or more illuminant conditions, the color matching functions, and the non-negative matrix factorization basis vectors to form an integrated result; and
b. performing a color transformation on the integrated result.

36. The image capturing system of claim 33 wherein the processing module is configured to integrate the color matching functions, the reflectance function, and the one or more illuminant conditions across a determined frequency domain.

37. The image capturing system of claim 34 wherein the frequency domain comprises the visible light domain.

38. The image capturing system of claim 29 wherein the color matching functions comprise three color matching functions.
